(19) United States
(12) Patent Application Publication
(10) Pub. No.: US 2025/0184148 A1
(43) Pub. Date: Jun. 5, 2025

(54) SYSTEM AND METHOD FOR IDENTIFICATION, AUTHENTICATION, AND VERIFICATION OF A PERSON BASED UPON A SHORT AUDIO-VISUAL RECORDING OF THE PERSON

(71) Applicant: UNIVERSITY OF WEST BOHEMIA IN PILSEN, Pilsen (CZ)

(72) Inventors: Kamil Ekštein, Pilsen (CZ); Miloslav Konopík, Pilsen (CZ); František Pártl, Pilsen (CZ); Patrik Patera, Pilsen (CZ)

(21) Appl. No.: 18/942,069

(22) Filed: Nov. 8, 2024

Related U.S. Application Data
(60) Provisional application No. 63/601,118, filed on Nov. 20, 2023.

(51) Int. Cl. H04L 9/32; G06V 40/16

(52) U.S. Cl. CPC H04L 9/3231; G06V 40/167; H04L 9/3236

(57) ABSTRACT

A method for computation of a complete hash from a multimedia recording of a person's face is provided. The method includes detection and localization of a person's face in an input image sequence with computation of an averaged facial representation of the person's face. The method further includes detection of a person's voice in an input multimedia file with computation of an averaged voice representation of the person's voice. The method also includes transforming the detected person's face into a partial fingerprint. The method also includes transforming the detected person's voice into a partial fingerprint. The method further includes comparison of two partial face fingerprints and of two partial voice fingerprints by computing a similarity measure.

### CROSS-REFERENCE TO RELATED APPLICATIONS

This application claims the benefit of U.S. Provisional Patent Application No. 63/601,118, filed Nov. 20, 2023, which is incorporated, in its entirety, by this reference.

### TECHNICAL FIELD

The present disclosure relates generally to systems and methods for personal identification.

### BACKGROUND OF CERTAIN ASPECTS OF THE DISCLOSURE

At least some computerized systems may identify a person based on the person's unique signature. For example, when a postal service delivers a parcel, the entire process is automated such that each parcel has a unique identifier to identify the parcel at each depot along the delivery route. That is, each parcel has an identifier (barcode, QR code) and is time stamped and each postal vehicle has a uniquely identifier such that the parcel is tracked along the entire delivery route. However, the only entity without a suitable electronically accessible identifier is the addressee of the parcel.

The addressee may have an electronic signature; however, the electronic signature is not something that can be easily used when a postman delivers the parcel. At delivery, the computerized postal service requires the addressee to provide a very traditional hand-written signature which is converted into a digital signature for the post office digital systems. The postman typically asks the recipient to sign a tablet, a smartphone display, or a similar specialized electronic device. Signing the tablet is awkward because the tablet is a surface that is significantly different than paper using either one's finger or some kind of pointing device. FIG. 1 illustrates the difference between a signature captured on paper and a signature captured on a tablet.

Signatures provided electronically as shown in FIG. 1 are of little practical value for identity verification when the recipient denies the reception of the parcel. Accordingly, there is a need for a system and method that accurately and electronically identifies the recipient of a parcel.

### BRIEF SUMMARY OF SOME ASPECTS OF THE DISCLOSURE

One aspect of the present disclosure relates to a method for computation of a cryptographic hash corresponding to the short audio-visual recording of a person, which consists of two partial hashes (fingerprints)—one for visual input (the video recording of the person's face) and one for acoustic input (the audio recording of the person's voice). The method includes detection and localization of a person's face in an input image sequence with computation of an averaged facial representation of the person's face. The method further includes detection of a person's voice in an input multimedia file with computation of an averaged voice representation of the person's voice. The method also includes transforming the detected person's face into one of the partial hashes of the two partial hashes. The method also includes transforming the detected person's voice into one of the partial hashes of the two partial hashes. The method further includes comparison of complete hashes assembled from partial face fingerprints and partial voice fingerprints by computing a similarity measure.

There are other novel aspects and features of this disclosure. They will become apparent as this specification proceeds. Accordingly, this brief summary is provided to introduce a selection of concepts in a simplified form that are further described below in the detailed description. The summary and the background are not intended to identify key concepts or essential aspects of the disclosed subject matter, nor should they be used to constrict or limit the scope of the claims. For example, the scope of the claims should not be limited based on whether the recited subject matter includes any or all aspects noted in the summary and/or addresses any of the issues noted in the background.

### BRIEF DESCRIPTION OF THE DRAWINGS

A further understanding of the nature and advantages of the embodiments may be realized by reference to the following drawings. In the appended figures, similar components or features may have the same reference label.

FIG. 1 illustrates an example of signatures captured with a smart phone and pen and paper in accordance with aspects of the present disclosure.

FIG. 2 illustrates examples of input that are converted into hashes in accordance with aspects of the present disclosure.

FIG. 3 illustrates an example of a system architecture in accordance with aspects of the present disclosure.

FIG. 4 illustrates an example of another system architecture in accordance with aspects of the present disclosure.

FIG. 5 illustrates an example of a flow diagram of a transformation of input into a hash in accordance with aspects of the present disclosure.

FIG. 6 illustrates an example of a flow diagram of a method for computation of a partial hash in accordance with aspects of the present disclosure.

FIG. 7 illustrates an example of a diagram of a system including a device in accordance with aspects of the present disclosure.

FIG. 8 illustrates an example of a photograph of a user using the systems shown in FIGS. 1-7 in accordance with aspects of the present disclosure.

FIG. 9 illustrates an example of a photograph of a user using the systems shown in FIGS. 1-8 in accordance with aspects of the present disclosure.

FIGS. 10-14 illustrates code that may be used to control the systems shown in FIGS. 1-9 in accordance with aspects of the present disclosure.

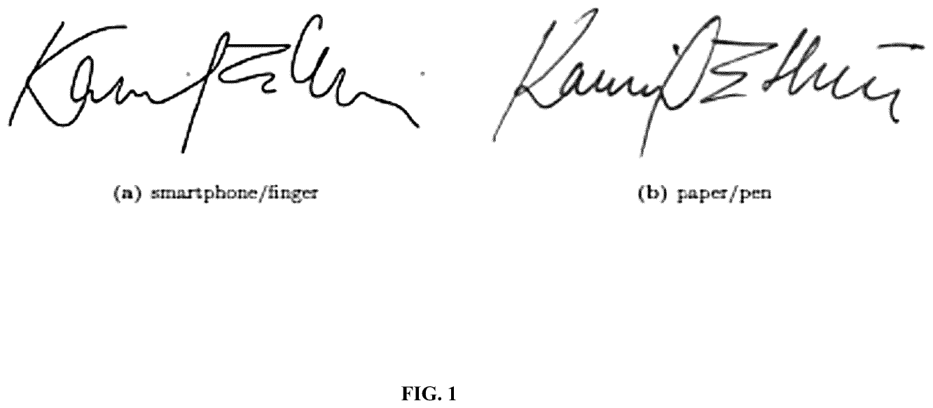

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods disclosed herein relate to, among other things a deterministic algorithmic transformation of short (3 to 6 seconds long) footage (audio-visual recording) of a face (or a bust) of a person saying out loud a short sentence, usually containing their name and a statement about the recorded situation, like, e.g., “receiving the parcel”, or “signing the document”, etc. The recording is transformed through an algorithmic sequence of mathematical and data manipulation operations into a binary representation (a long string of zeros and ones), possibly a vector of real numbers or a large integral number.

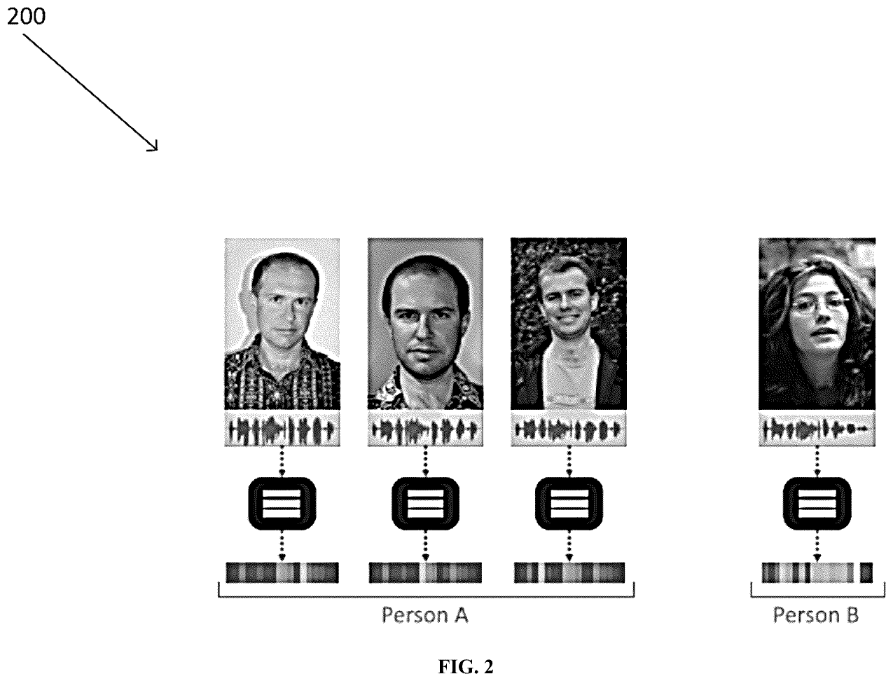

An advantage of the transformation is that no matter whether the recorded person changed their appearance (haircut, makeup, accessories, etc.) or whether the recording environment changed, the transformation produces in more than 99% of cases hashes that can be positively attributed to the respective unique person as shown in FIG. 2. When the recordings of the same person differ substantially, the resulting hashes may be different, too. However, a similarity measure is calculated that can positively state whether the respective hashes originate from recordings of the same person.

Thus, the presented technology includes: (i) algorithmically transforming the input audio-visual recordings into hashes and (ii) comparing the hashes to determine whether two hashes correspond to the same person.

An advantage of the systems and methods described herein is that the input audio-visual recordings are no longer needed after the processing, i.e., after the transformation into hashes. Only the hashes are stored (in a database, maybe) and not the recordings. Both the video and the audio components may be erased after the processing to leave no unwanted electronic trace of the signee. The transformation is a unidirectional process, and there is no way to reconstruct the appearance or the voice of the signee. The mathematical properties of the transformation process prevents reverse engineering of the hashes into the video and the audio components. Therefore, the systems and methods described herein protect the privacy of the signees.

Another important positive quality is that only a very short recording is needed as the multimedia signature of a person. The typical length of the multimedia signature ranges between 3 and 6 seconds. This saves the time of both the signee and the operator. Additionally, the processing of such a reduced amount of data is faster and less computationally demanding. The communication network traffic is then reduced as only the hash (1904 bytes) is transferred instead of the whole audio-visual recording of several megabytes. Competing solutions usually need significantly longer recordings and/or several attempts. Moreover, the recordings are often stored in a database in an unmodified form.

The systems and methods described herein include: (1) use of an audio-visual recording of the face and the voice of a person to create a unique digital “fingerprint” of a fixed length with properties similar to those of the digital signature keys; (2) use of signing documents/countersigning acts using just the respective person's appearance and voice, and later verifying the authenticity of the signature using again the audio-visual recording of an utterance by the respective person; and (3) transforming the audio-visual recording into the multimedia signature, i.e., the sequence of mathematical operations to get the hash from the clip.

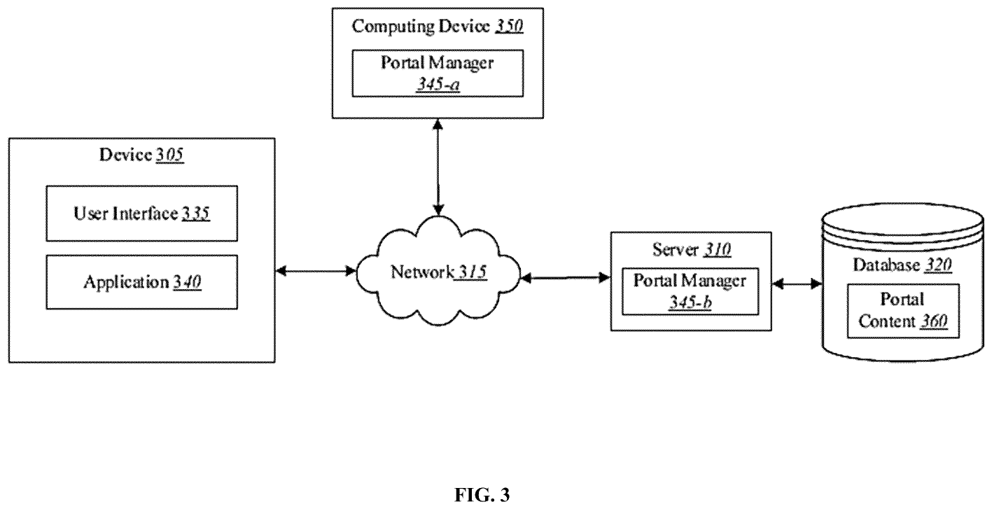

FIG. 3 illustrates a block diagram of one example of a system 300 in which the present systems and methods may be implemented. In some examples, the systems and methods described herein may be performed on a device (e.g., device 305). As depicted, the system 300 may include a device 305, server 310, a network 315, and a computing device 350, and that allows the device 305, the server 310, and the database 320 to communicate with one another.

Examples of the device 305 may include any combination of, for example, mobile devices, smart phones, personal computing devices, computers, laptops, desktops, servers, media content set top boxes, or any combination thereof.

Examples of computing device 350 may include at least one of one or more client machines, one or more mobile computing devices, one or more laptops, one or more desktops, one or more servers, one or more media set top boxes, or any combination thereof.

Examples of server 310 may include, for example, a data server, a cloud server, proxy server, mail server, web server, application server, database server, communications server, file server, home server, mobile server, name server, or any combination thereof.

Although database 320 is depicted as connecting to device 305 via network 315, in some examples, device 305 may connect directly to database 320. In some examples, device 305 may connect or attach to at least one of database 320 or server 310 via a wired or wireless connection, or both. In some examples, device 305 may attach to any combination of a port, socket, and slot of a separate computing device or server 310.

In some configurations, the device 305 may include a user interface 335 and an application 340. Although the components of the device 305 are depicted as being internal to the device 305, it is understood that one or more of the components may be external to the device 305 and connect to device 305 through wired or wireless connections, or both. Examples of application 340 may include a web browser, a software application, a desktop application, a mobile application, etc. In some examples, application 340 may be installed on a computing device in order to allow a user to interface with a function of device 305, server 310, and computing device 350.

Although device 305 is illustrated with an exemplary single application 340, in some examples application 340 may represent two or more different applications installed on, running on, or associated with device 305. In some examples, application 340 may include one or more software widgets. In some cases, application 340 may include source code to operate one or more of the systems or system components described herein.

In some examples, device 305 may communicate with server 310 via network 315. Examples of network 315 may include any combination of cloud networks, local area networks (LAN), wide area networks (WAN), virtual private networks (VPN), wireless networks (using 805.11, for example), cellular networks (using 3G, LTE, or 5G, for example), etc. In some configurations, the network 315 may include the Internet. For example, device 305 may include application 340 that allows device 305 to interface with a separate device such as a separate computing device, server 310, database 320, or any combination thereof.

In some examples, at least one of device 305, database 320, and server 310 may include application 340 where at least a portion of the functions of application 340 are performed separately or concurrently on device 305, database 320, and/or server 310. In some examples, a user may access the functions of device 305 (directly or through device 305 via application 340) from database 320 or server 310. In some examples, database 320 includes a mobile application that interfaces with one or more functions of device 305, server 310, or application 340.

In some examples, server 310 may be coupled to database 320. Database 320 may be internal or external to the server 310. In one example, device 305 may be coupled to database 320. In some examples, database 320 may be internally or externally connected directly to device 305. Additionally, or alternatively, database 320 may be internally or externally connected directly to computing device 350 or one or more network devices such as a gateway, switch, router, intrusion detection system, etc. Database 320 may include application 340. In some examples, device 305 may access or operate aspects of application 340 from database 320 over network 315 via server 310. Database 320 may include script code, hypertext markup language code, procedural computer programming code, compiled computer program code, object code, uncompiled computer program code, object-oriented program code, class-based programming code, cascading style sheets code, or any combination thereof.

In one example, device 305 may be coupled to database 320. In some examples, database 320 may be internally or externally connected directly to device 305. Additionally, or alternatively, database 320 may be internally or externally connected directly to one or more network devices such as a gateway, switch, router, intrusion detection system, etc.

Application 340 may enable a variety of features and functionality related to the systems and methods described herein. In some examples, application 340 may be configured to perform the systems and methods described herein in conjunction with user interface 335. User interface 335 may enable a user to interact with, control, or program one or more functions of application 340.

Even without the application 340 installed, accessing the application 340 may be relatively easy for a user by simply visiting a predetermined URL in the user's mobile browser. By simply searching for the application 340 or typing the predetermined URL into the browser it will display the application 340 if the user does not have the application 340 installed on their mobile computing device or the mobile computing device will open the application 340 and show them the application 340.

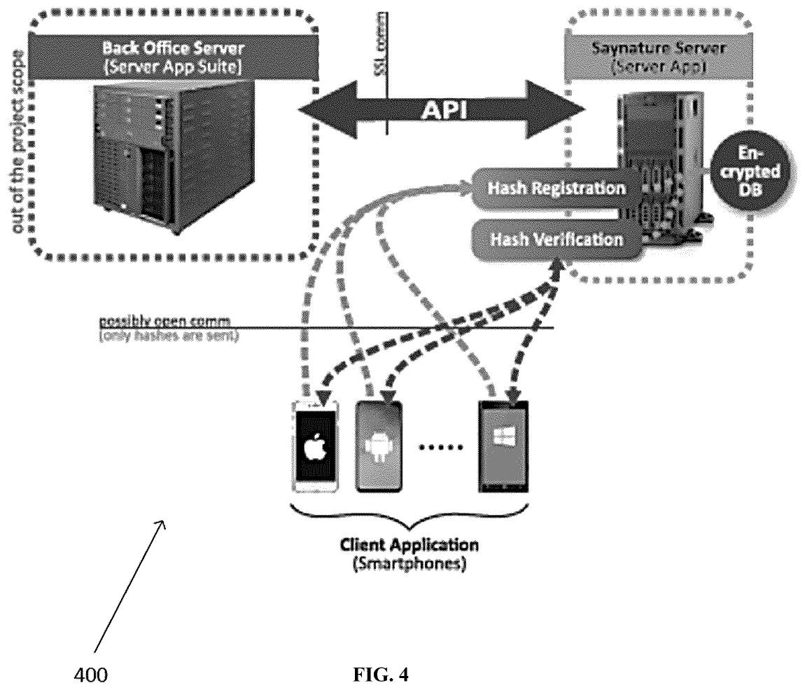

FIG. 4 illustrates an example of a portion of a system architecture 400 that supports the systems and methods described herein. In some examples, system architecture 400 may implement aspects of system 300. In the illustrated example, system architecture 400 is an example of the underlying components, functions, and structure used to carry out one or more of the methods disclosed herein. The system 400 is exemplary only of some or all of the inventive aspects of the present disclosure. Other example systems and methods and possible that include more or feature steps, components or other features than those illustrated in the other figures described herein.

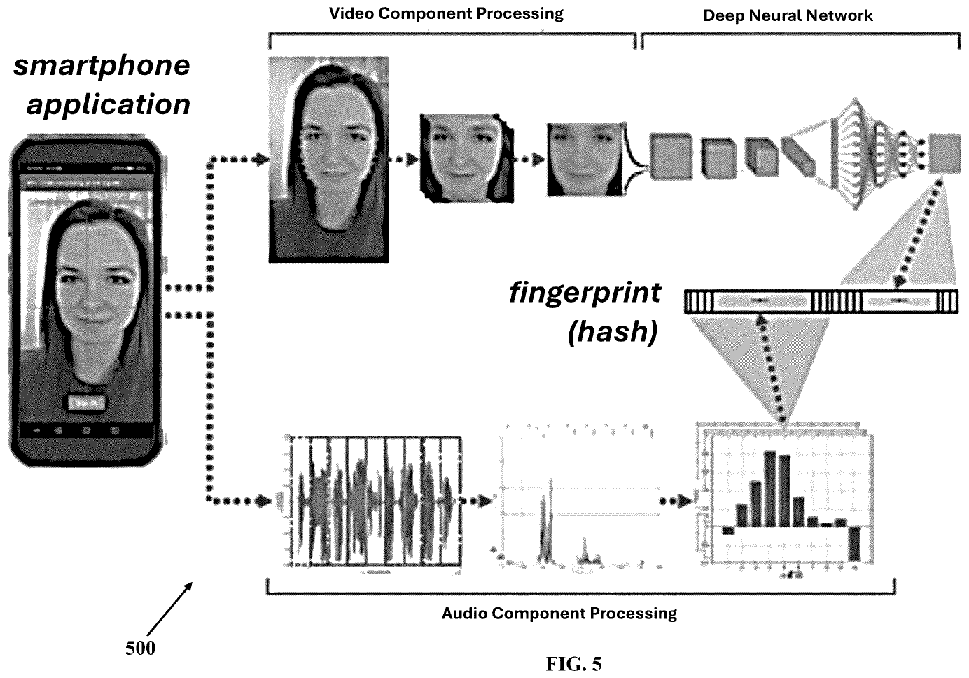

As shown in FIG. 5, the computation of the partial hash (also referred to as fingerprint) of the visual component of a person's multimedia signature can be divided into three more or less independent parts: (a) detection and localization of the person's face in the input image sequence with computation of the averaged facial representation of the person, (b) transforming the detected face into a partial fingerprint, and (c) comparison of two partial fingerprints by computing their similarity measure.

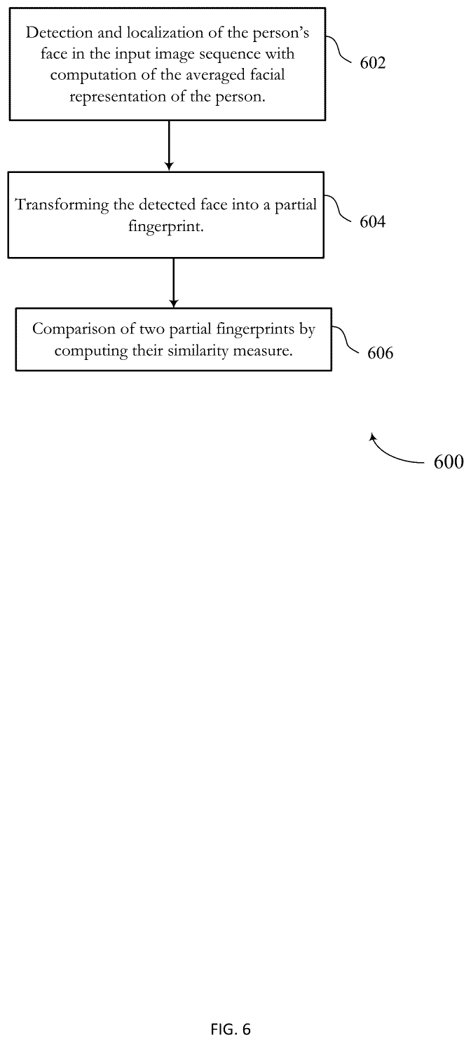

FIG. 6 shows a flow chart illustrating a method 600 for computation of a partial hash in accordance with aspects of the present disclosure. The operations of method 600 may be implemented by a device or its components as described herein. For example, the operation of method 600 may be performed by an application 340 as described with reference to FIG. 3. The application 340 described with reference to FIG. 3 may operate to perform some or all of the functions associated with the system 300 described with reference to FIG. 3. In some examples, a device may execute a set of instructions to control the functional elements of the device to perform the functions described herein. Additionally, or alternatively, a device may perform aspects of the functions described herein using special purpose hardware.

The method 600 includes: detection and localization 602 of the person's face in the input image sequence with computation of the averaged facial representation of the person, transforming 604 the detected face into a partial fingerprint, and comparison 606 of two partial fingerprints by computing their similarity measure.

Detection and localization 602 of the person's face in the input scene (a) is performed using the procedure described below:
(i) The input to the algorithm is the visual component of the multimedia signature of a person. The visual component in the form of a sequence of single frames is extracted from the MP4 format recording (acquired by a smartphone or a similar device) using the OpenCV library.
(ii) Each frame is transformed into a matrix of pixel intensities, which is rescaled to half of the original size using bilinear interpolation.
(iii) The presence of a person's face in the input image is detected by the linear (kernel-less) Support Vector Machine (SVM) classifier that uses the Histogram Of Gradients (HOG) parameterization of the input image as the classifier input feature vector. The standard implementation from the Dlib library is used in this step.
(iv) If no face is found in the image, then the image is discarded. If multiple faces were detected, only the one closest to the geometric center of the input image is extracted (this is based upon an assumption about how the recordings are taken).
(v) The so-called facial landmarks (mutual positions of eyes, chin, nose, lips, etc.) are detected and localized on the extracted input image using the pre-trained model called shape_predictor_68_face_landmarks, which is available from the Dlib webpage as a part of the implementation of the technique called One Millisecond Face Alignment with an Ensemble of Regression Trees introduced by Vahid Kazemi and Josephine Sullivan.
(vi) Based upon the detected facial landmarks, the image is aligned and cropped. The cutout image is rescaled to a dimension of 150×150 pixels so that all images contain the face in the same central position.
(vii) The width to height ratio of the mouth and eyes, respectively, is calculated for each image. Of all the found faces, i.e., the images containing a face, only those with the mentioned ratios in the interval (Q1, Q3) are retained. The quartile values are determined from the calculated ratios over all the available images.
(viii) From all found faces (images) in the input image sequence (there has to be at least 5 of such), an “average face” is calculated as the arithmetic mean of the pixel intensities at the corresponding positions.

Computation of the partial face fingerprint (b) is performed by the forward run of the trained convolutional neural network implemented in the Dlib library. The architecture of this network (called ResNet-34) originates from the text of Kaiming He, Xiangyu Zhang, Shaoqing Ren, Jian Sun: Deep Residual Learning for Image Recognition. However, it was modified to use only 29 hidden layers, and the number of filters in each layer was reduced to one half of the original amount.

The input of the computational procedure is an image (i.e., a matrix of pixel intensities) having 150×150 pixels, i.e., a point in R²²⁵⁰⁰ space. The output is then (due to the neural network architecture) a point in the R¹²⁸ space. The activation function used throughout the whole network is ReLU, all convolution kernels are of size 3×3, layers 1-7 use 32 filters (neurons), layers 8-15 use 64 filters (neurons), layers 16-21 use 128 filters (neurons), and layers 22-29 use 256 filters (neurons). The output of this deep convolutional neural network (i.e., the vector of activations in the output layer) acts as the partial fingerprint of the face. Exact values of the hyper parameters disclosed herein are representative and may be varied or changed without departing from the scope of the embodiments of this disclosure.

The visual component of the audio-visual recording is processed in order to find a person's face in it, and if found, the cropped face image is transformed into a 128-dimensional vector of real numbers, v∈R¹²⁸.

The comparison of two partial fingerprints of the visual component of the input audio-visual recording by calculating the measure of their mutual similarity (c) is accomplished via the procedure described below:
(i) The distance between the two fingerprints is calculated as the Euclidean distance between the two points in R¹²⁸ as each fingerprint is in fact a 128-dimensional real vector.
(ii) If the distance is less than or equal to 0.47, it is a 100% match.
(iii) If the distance is greater than or equal to 0.6, the match is considered to be 0%.
(iv) A distance value in the interval (0.47, 0.6) is converted to a probabilistically interpretable match ratio with a uniform probability distribution. What does the match mean? If the two partial fingerprints match according to the above-defined conditions, the visual component of the input recording pictures the same person.

The partial fingerprint of the audio component of a person's multimedia signature (voice fingerprint) is calculated from the acoustic signal digitized and stored in the Pulse Code Modulation (PCM) format as a part of the audio-visual recording. The goal is to obtain a single vector of real values that unambiguously identifies the recorded person's voice. The partial fingerprint of the audio component has 110 elements, a ∈R¹¹⁰.

The voice fingerprint computation is performed using the procedure described below:
(i) The input to the algorithm is the audio component of the multimedia signature of a person. The audio component (or track hereafter) in the form of a digital audio signal encoded using the PCM technique is extracted from the input audio-visual recording in MP4 format (acquired by a smartphone or a similar device) by means of the standard open-source tool, FFmpeg. The acoustic signal in PCM is downsampled to 8 kHz, and each sample is stored as a 32-bit signed integer.
(ii) The mean value of the acoustic signal is normalized (thus, removing DC offset, if any) and then pre-emphasis is applied with a value of α=0.97.
(iii) The signal is divided into time windows (the so-called frames), each containing 256 signal samples. The frames have 50% overlap, i.e., two adjacent frames have 128 samples in common.
(iv) In all the frames, the signal energy Em is calculated as the numerical Newton integral of the square of the signal function, i.e., Em=∫s²(t) dt. The calculated energies of all frames are used to get the mean value of energy over the whole signal, Em. The frames of which the energy satisfies the inequality Em<ηEm are marked as silent (without any voice activity). The silent frames are ignored in the further processing. The threshold value n is set empirically to value n=0.1.
(v) The frames are then windowed (tapered) by the Hamming weighting window with standard values α=0.54 and β=0.46.
(vi) The signal in each frame is transformed into the frequency domain by computing its power spectral density estimate via the Fast Fourier Transform (FFT) algorithm.
(vii) Each power spectral density estimate is used to compute the Mel-Frequency Cepstral Coefficient (MFCC) vector. The computation produces 129 values of the Mel-scaled triangle filters—these are taken to get 110 cepstral coefficients.
(viii) All the MFCC vectors obtained via the above-described procedure (i.e., one vector for each frame of the input signal) are summed to get the average vector, i.e., 110-dimensional vector where each element represents the mean value of the respectively positioned elements in the MFCC vector sequence. The resulting average vector plays the role of the voice fingerprint of a person, and it is the output of the algorithm.

Thus, the audio component of a person's multimedia signature is projected into the R¹¹⁰ space as a single point by the above-described process. Each person is then represented by a point in this 110-dimensional space of real vectors, and if we want to find out whether 2 different projections represent the same person, or his/her multimedia signature respectively, or an entirely different person, we need to calculate the degree of similarity of the two projections (fingerprints). The similarity measure of two fingerprints is calculated as follows:
(i) The input to the algorithm are the two compared partial fingerprints (110-dimensional vectors) x and y.
(ii) The mutual distance of the fingerprints d(x, y) is at first determined by the standard Dynamic Time Warping (DTW) algorithm for scoring the similarity of two not exactly same sequences of values such that they naturally vary in the values of elements but may also vary in length.
(iii) The similarity measure is then determined upon the following consideration:

The maximum distance between the fingerprints belonging to the same person is different for each unique person (the interclass variability varies).

The average of these distances is taken as the mean value μ of the normal (Gaussian) distribution, whose 5% or 95% quantile is the value of the minimum or the maximum of the observed distances, respectively.

The distribution proposed by the above consideration is then integrated to produce a prescription for the similarity measure parameterized by the result of the DTW algorithm:

$${similarity}_{x} ( x , y ) = \frac{1}{2} erf ( 3.05582 - 0.115731 \cdot d ( x , y ) ) + \frac{1}{2}$$

$$The function produces real output values in the range from 0 to 1 ,$$

$$similarity ( x , y ) ∈ ℝ ⋂ 〈 0 , 1 〉 . The erf function used in the calculation$$

$$is the so - called Gauss error function , erf ( z ) = \frac{2}{\sqrt{π}} {\int }_{0}^{2} {e}^{- {t}^{3}} dt .$$

The resulting final combined similarity measure of two multimedia signatures X and Y of the person(s) (i.e., the audio-visual recordings in MP4 format described above) is obtained from the following formula:

$$similarity ( x , y ) = 0.2 \cdot {similarity}_{x} ( x , y ) + 0.8 \cdot {similarity}_{x} ( x , y ) ,$$

where similarity is the similarity of the partial fingerprints of the audio components (voices) of the persons' multimedia signatures and similarity is the similarity of the partial fingerprints of the visual components (faces).

The high confidence of the hash similarity assessment (over 99% in the testing stage of the development), the systems and methods described herein may be and is intended to be used as a replacement of the traditional handwritten signature in situations where it is not practicable for the signee to put his/her signature down onto a paper.

For example, a first application of the systems and methods described herein includes a paperless office. A document circulates through an establishment in an electronic form, most likely (and preferably) in the PDF format. Then, at a certain moment, somebody signs it. They take their smartphone with the systems and methods described herein and record with it their face saying aloud their name and somehow expressed approval with signing the respective document, like, e.g., “John Doe, signing the document ABC.” The application generates the multimedia signature. The multimedia signature is a hash (a sequence of bits) that can be either encoded into a QR code and placed onto the document or used as a key for some standard cryptographic techniques, such as SSH, or used as a key for the internal Adobe-provided document signing mechanism. The use depends on the architecture and specific implementation of the paperless office support IT system.

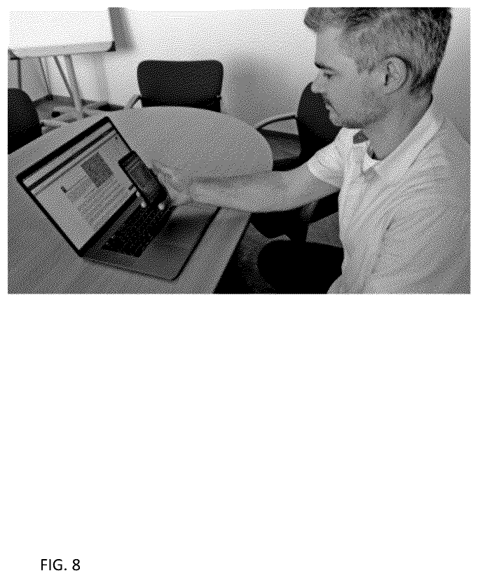

Whenever somebody (the verifier) from the establishment wants to check whether the signature is authentic, they asks the signee of the respective document to say aloud his/her name and the utterance used when signing the document. The verifier records this using the smartphone with the systems and methods described herein, and it computes the hash and compares it with the hash stored in the document (by reading the QR code on the document) as shown in FIG. 8. Immediately, the application indicates whether the signature is authentic, and the document was signed by the recorded individual (the signee), or not.

A second application of the systems and methods described herein includes a postal service. When a parcel is delivered by a postal service, their operator collects the recipient's multimedia signature using the systems and methods described herein in his/her smartphone. The recipient says aloud his/her name and possibly some identification of the act, like e.g. “receiving the parcel”. This utterance is optional and does not play any important role in the multimedia signature computation, it is needed just for the case when the recipient's name is too short and the recording would not have at least 3 seconds.

The multimedia signature (the hash) is computed by the application and is then sent to the postal service server where it is associated with the delivery identification and stored.

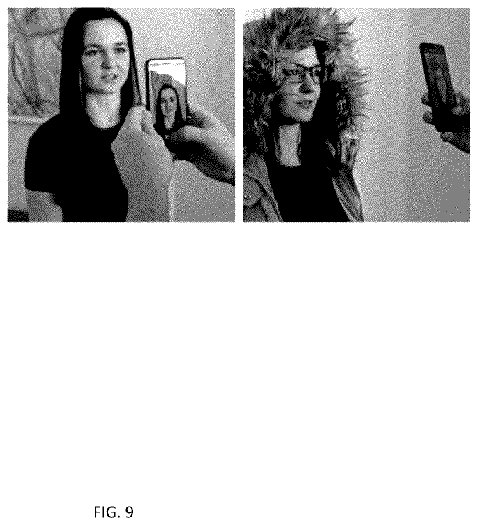

Later, if there is a need to verify whether the recipient received the consignment (and countersigned so), the operator asks the respective person to say aloud his/her name and the identification of the act (“receiving the parcel”, etc.)) as shown in FIG. 9. Right after the recording, the application computes the hash and compares it to the hash associated with the known (formerly stored) delivery identification obtained from the postal service server. The application shows the result to the operator immediately, and it might be (a) the multimedia signatures are the same (thus, the original recipient and the tested person is the same individual with over 99% reliability), or (b) the multimedia signatures differ (the persons are not the same).

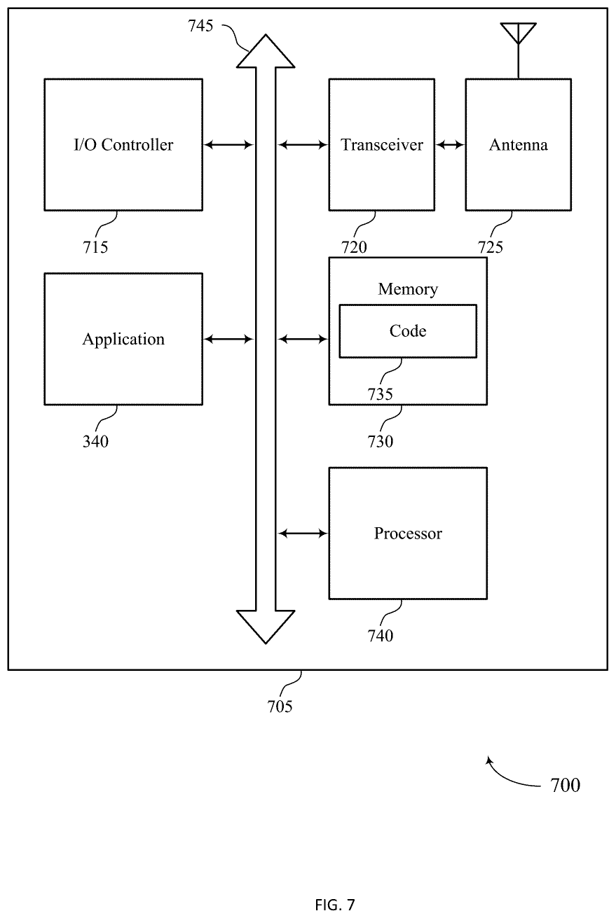

FIG. 7 shows a diagram of a system 700 including a device 705 that supports the systems and methods described herein in accordance with aspects of the present disclosure. The device 705 may be an example of or include the components of device 305 or devices as described herein. The device 705 may include components for bi-directional voice and data communications including components for transmitting and receiving communications, including the application 340, an I/O controller 715, a transceiver 720, an antenna 725, memory 730, a processor 740, and a coding manager 735. These components may be in electronic communication via one or more buses.

The application 340 may provide any combination of the operations and functions described above related to the system architecture 300 and the methods described herein.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described herein. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting menu related functions and other functions associated with the systems and methods disclosed herein).

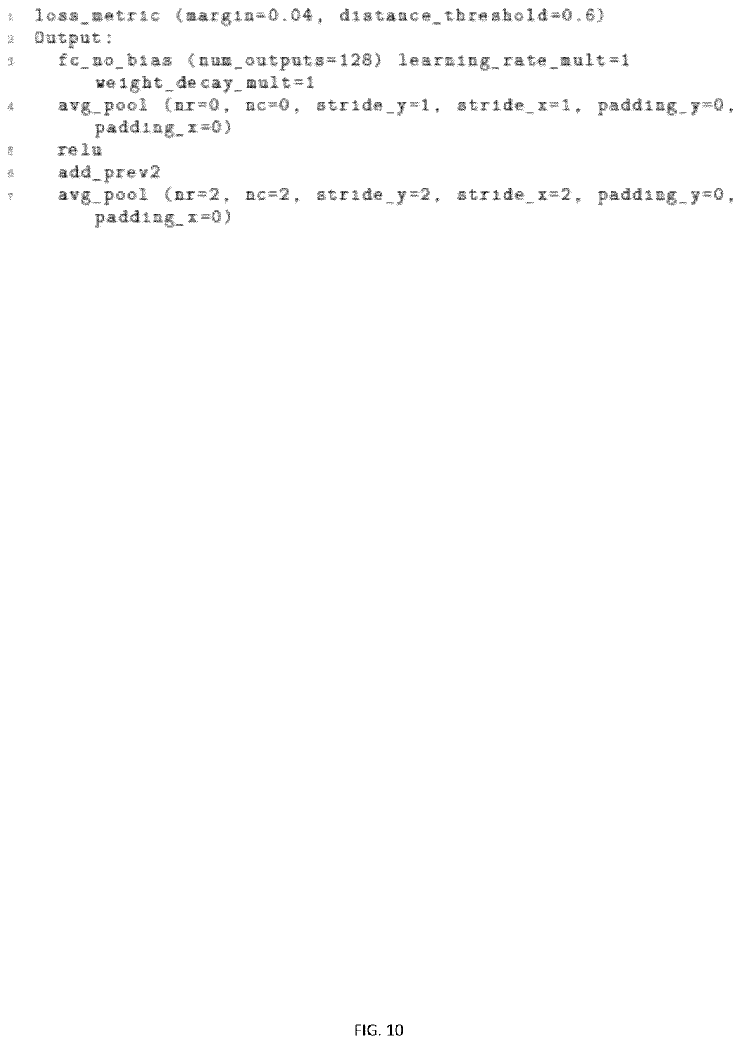

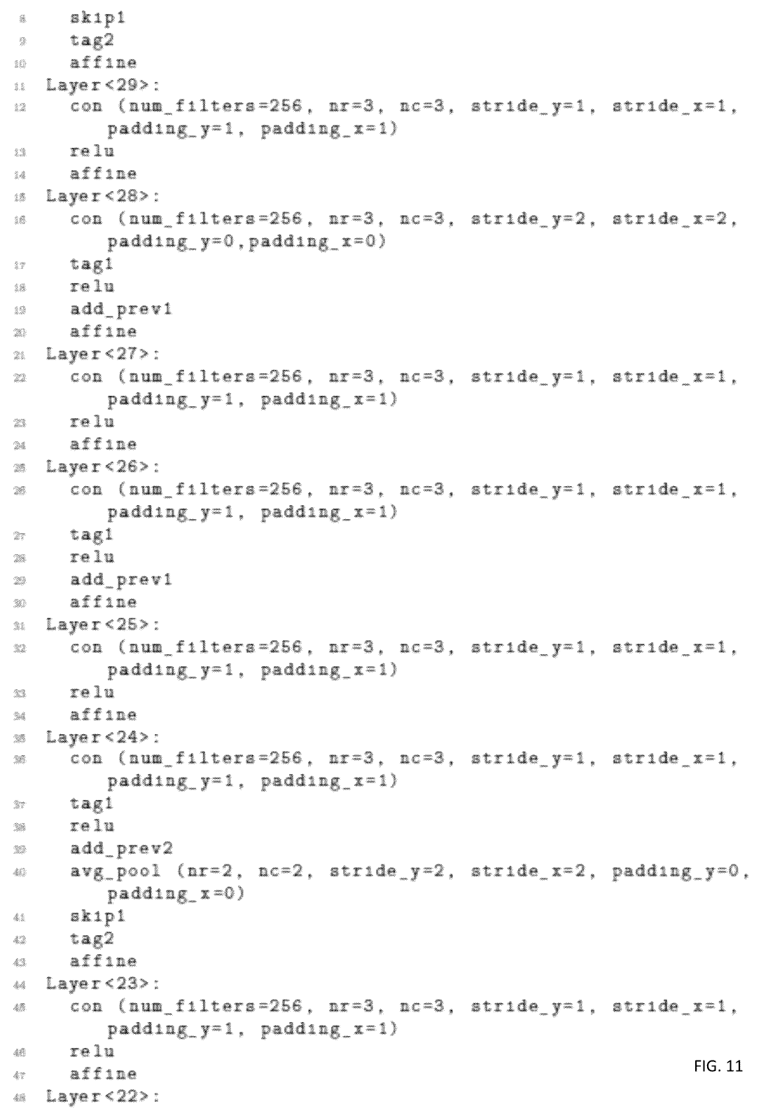

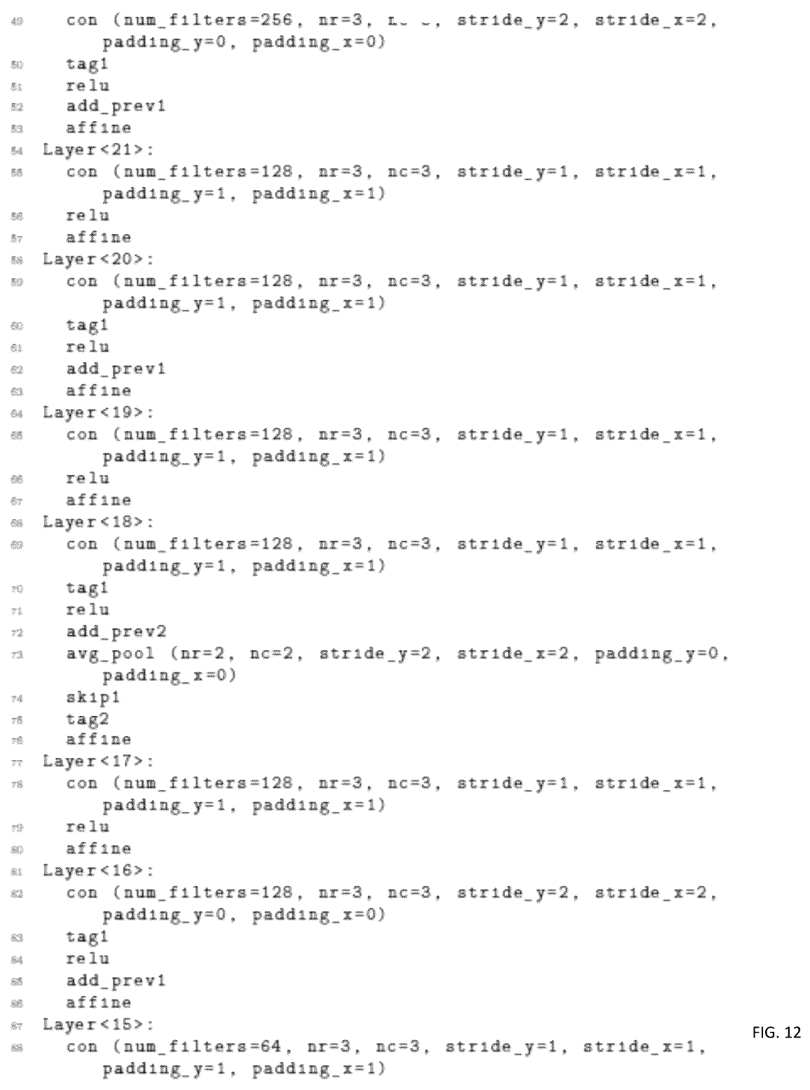

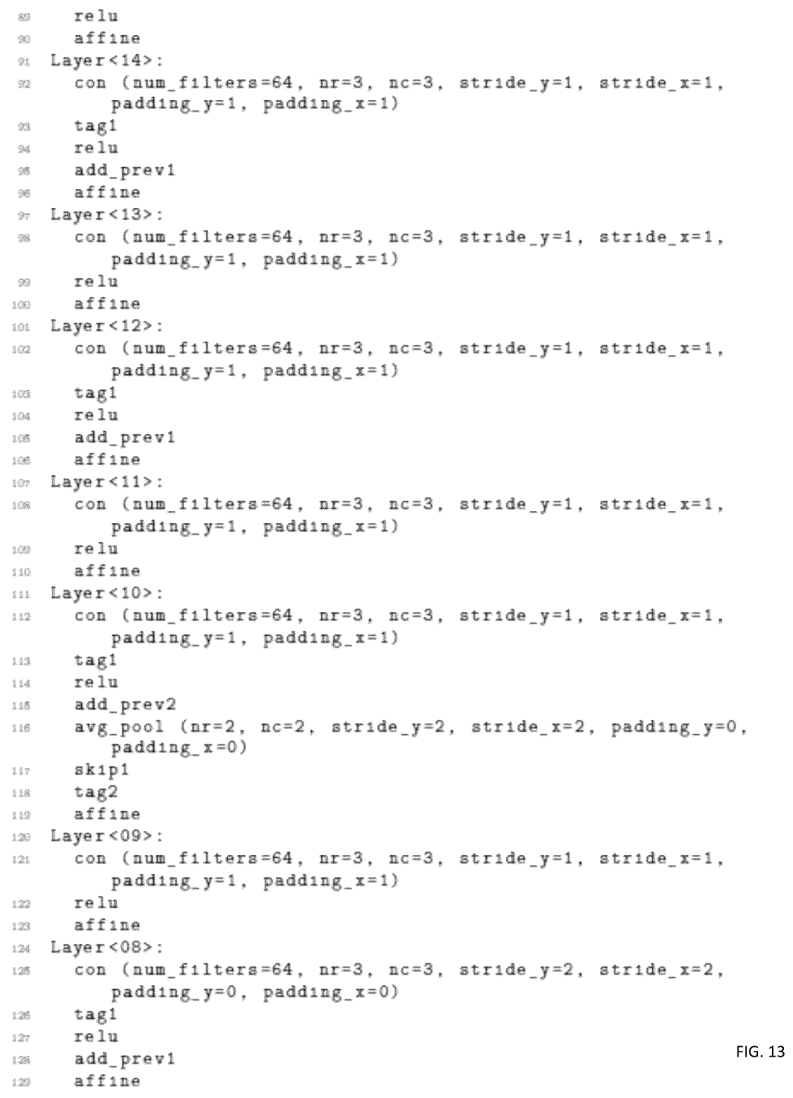

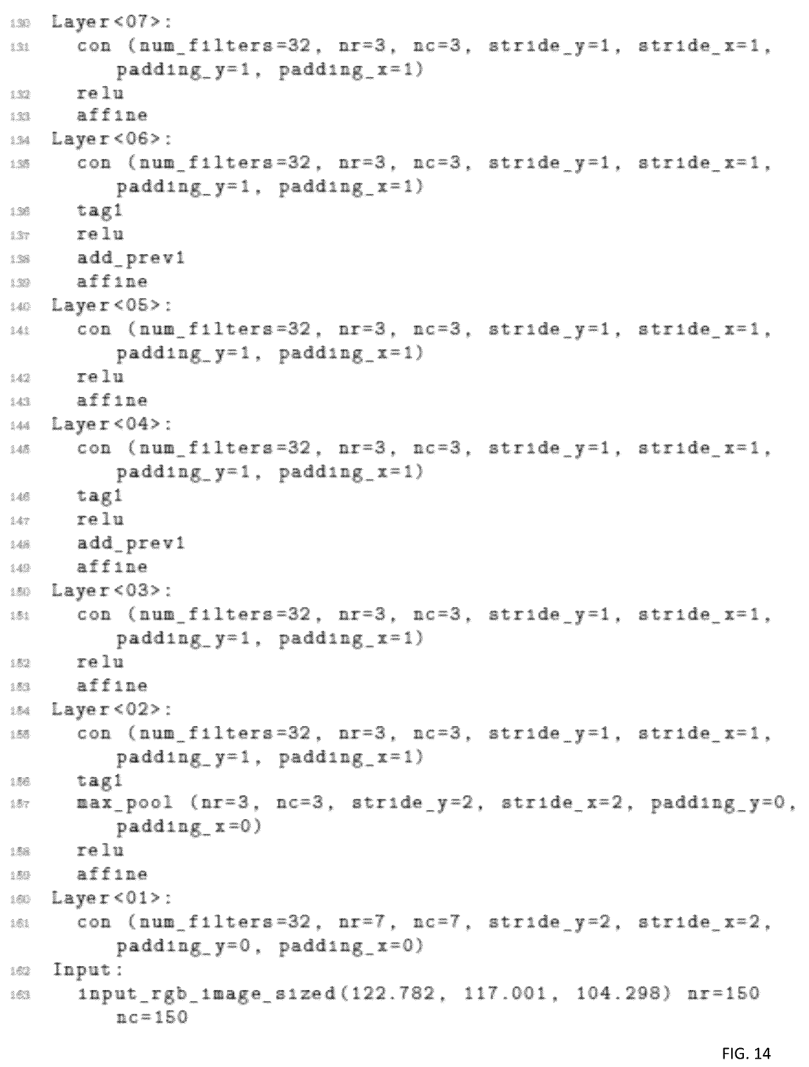

The code 735 may include instructions to implement aspects of the present disclosure. The code 735 may be stored in a non-transitory computer-readable medium such as system memory or other type of memory. In some cases, the code 735 may not be directly executable by the processor 740 but may cause a computer (e.g., when compiled and executed) to perform functions described herein. Detailed description of the deep convolutional neural network architecture (a modification of the published ResNet-34 architecture)—used in the presented technique to generate the partial fingerprint of a person's multimedia signature from the visual component of the input audio-visual recording is shown in FIGS. 10-14.

It should be noted that the methods described herein describe possible implementations, and that the operations and the steps may be rearranged or otherwise modified and that other implementations are possible. Furthermore, aspects from two or more of the methods may be combined.

If wireless communications are used, the techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 805.11 (Wi-Fi), IEEE 805.16 (WiMAX), IEEE 805.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein may include one or more carriers.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical venues. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

### Terminology and Interpretative Conventions

As used herein, audio-visual recording means footage (or clip) of a person (signee) taken by a smartphone or a similar portable computer/electronic device stored in the technology standard format MP4 as described by the ISO/IEC 14496-14:2003 document (see https://www.iso.org/standard/38538.html).

As used herein, multimedia signature means an audio-visual recording used for the purpose of identification, authentication, and verification of a person while using the systems and methods described herein. The recording may contain the signee's head or the whole bust from a frontal view angle, preferably straighten face. It also contains an audio track with the signee's utterance about the recorded act, i.e., accepting a consignment, signing a document, etc.

As used herein, fingerprint means a binary representation of the input multimedia signature of a person after being processed by the systems and methods described herein. The fingerprint may be a very large integral number or a vector of (shorter) real numbers. Unlike the input audiovisual recording, which may be of arbitrary size (typically 10-60 MB), the fingerprint has a fixed length (namely 238 real values in the double format (IEEE 754 Standard), or 1904 bytes). The processing of each unique input audio-visual recording results in its unique fingerprint.

Any methods described in the claims or specification should not be interpreted to require the steps to be performed in a specific order unless stated otherwise. Also, the methods should be interpreted to provide support to perform the recited steps in any order unless stated otherwise.

Spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The terms have, having, include, and including should be interpreted to be synonymous with the terms comprise and comprising. The use of these terms should also be understood as disclosing and providing support for narrower alternative embodiments where these terms are replaced by “consisting” or “consisting essentially of.”

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

All disclosed numerical values are to be understood as being variable from 0-100% in either direction and thus provide support for claims that recite such values or any and all ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range (e.g., 15.2).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

The subject matter recited in the claims is not coextensive with and should not be interpreted to be coextensive with any embodiment, feature, or combination of features described or illustrated in this document. This is true even if only a single embodiment of the feature or combination of features is illustrated and described in this document.

What is claimed:

1. A method for the computation of a cryptographic hash, the method comprising:
detecting and localizing a person's face in an input image sequence;
detecting the person's voice in an input multimedia file;
transforming the detected person's face into a partial fingerprint;
transforming the detected person's voice into a partial fingerprint; and
comparing two complete hashes assembled from partial face fingerprints and partial voice fingerprints by computing a similarity measure.

2. The method of claim 1, wherein detecting and localizing a person's face in an input image sequence includes computation of an averaged facial representation of the person's face.

3. The method of claim 1, wherein detecting the person's voice in an input multimedia file includes computation of an averaged voice representation of the person's voice
